(19) United States
(12) Patent Application Publication
(10) Pub. No.: US 2014/0375575 A1
(43) Pub. Date: Dec. 25, 2014

(54) STYLUS PEN AND TOUCHSCREEN MODULE

(71) Applicant: SAMSUNG ELECTRO-MECHANICS CO., LTD., Suwon (KR)

(72) Inventors: Yong II KWON, Suwon (KR); Tah Joon Park, Suwon (KR); Moon Suk Jeong, Suwon (KR); Hyun Suk Lee, Suwon (KR)

(73) Assignee: SAMSUNG ELECTRO-MECHANICS CO., LTD., Suwon (KR)

(21) Appl. No.: 13/974,339

(22) Filed: Aug. 23, 2013

(30) Foreign Application Priority Data
Jun. 21, 2013 (KR) 10-2013-0071711

(51) Int. Cl. G06F 3/0354; G06F 3/041

(52) U.S. Cl. CPC G06F 3/03545; G06F 3/0412
USPC 345/173; 345/179

(57) ABSTRACT

There are provided a stylus pen and a touchscreen module. The stylus pen includes a receiving unit receiving a predetermined driving signal; a synchronizing unit generating a signal synchronized with the received driving signal; a frequency adjusting unit changing a frequency of the synchronized signal; and a transmitting unit transmitting a signal output from the frequency adjusting unit.

### CROSS-REFERENCE TO RELATED APPLICATIONS

This application claims the priority of Korean Patent Application No. 10-2013-0071711 filed on Jun. 21, 2013, with the Korean Intellectual Property Office, the disclosure of which is incorporated herein by reference.

### BACKGROUND OF THE INVENTION

1. Field of the Invention

The present invention relates to a stylus pen and a touchscreen module.

2. Description of the Related Art

A touch sensing device, such as a touchscreen or a touch pad, is an input device attached to a display device to provide an intuitive data input method to a user, and has recently been widely used in various electronic apparatuses, such as cellular phones, personal digital assistants (PDAs), navigation devices, and the like. In particular, as demand for smartphones has recently increased, the use of a touchscreen as a touch sensing device capable of providing a user with various data input methods in a restricted space has increased.

A touchscreen used in a portable device may be mainly classified as a resistive type touchscreen or a capacitive type touchscreen depending on a method of sensing a touch. Here, the capacitive type touchscreen has advantages in that it has a relatively long lifespan and may easily implement various input methods and gestures, such that the use thereof has increasingly increased. In particular, the capacitive type touchscreen may more easily allow for a multi-touch interface to be implemented, as compared to the resistive type touchscreen, such that it is widely used in devices such as smartphones.

Recently, as smartphone screen sizes have been increased and various applications developed for use therein, allowing a user to perform various fine data inputs to a screen of a smartphone or a tablet PC with the use of a stylus pen have increased.

The following Patent Document 1 relates to a touch pen in which a stylus pen receives a driving signal from a touchscreen device and then amplifies and outputs the driving signal in antiphase, such that the touchscreen device may not simultaneously recognize a touch from a finger, or the like, in addition to a touch from the stylus pen.

### RELATED ART DOCUMENT

### Patent Document

(Patent Document 1) Korean Patent Laid-Open Publication No. 10-2012-0100780

### SUMMARY OF THE INVENTION

An aspect of the present invention provides a stylus pen for changing a frequency of a signal synchronized with a signal received by a touchscreen device and a touchscreen module including the stylus pen so as to be able to simultaneously recognize a touch from a finger, and the like, and a touch from the stylus pen.

According to an aspect of the present invention, there is provided a stylus pen, including: a receiving unit receiving a predetermined driving signal; a synchronizing unit generating a signal synchronized with the received driving signal; a frequency adjusting unit changing a frequency of the synchronized signal; and a transmitting unit transmitting a signal output from the frequency adjusting unit.

The stylus pen may further include: a filter unit passing a signal within a preset frequency band, among the received driving signals.

The filter unit may include a band pass filter.

The stylus pen may further include an amplifying unit amplifying the received driving signal.

The amplifying unit may inversely amplify the received driving signal.

The synchronizing unit may include: a first comparator comparing a voltage of the received driving signal with a preset first reference voltage; a second comparator comparing the voltage of the received driving signal with a preset second reference voltage; an XNOR gate XNOR-operating output signals from the first and second comparators; and a D-flip flop including an input terminal having the output signal of the first comparator applied thereto and a clock signal terminal having an output signal of the XNOR gate applied thereto.

The first comparator may include an inversion terminal having the first reference voltage applied thereto and a non-inversion terminal having the received driving signal applied thereto, and the second comparator may include an inversion terminal having the second reference voltage applied thereto and a non-inversion terminal having the received driving signal applied thereto.

The first reference voltage may have a predetermined level of positive voltage and the second reference voltage may have a predetermined level of negative voltage.

The frequency adjusting unit may multiply or divide a frequency of a signal output from the synchronizing unit.

The driving signal may be generated in a controller integrated circuit of a capacitive touchscreen device and may be applied to an electrode of a panel unit of the touchscreen device.

According to another aspect of the present invention, there is provided a touchscreen module, including: the stylus pen as described above; and a touchscreen device including a panel unit and a controller integrated circuit detecting a change in capacitance by applying a predetermined driving signal to the panel unit to sense a touch from the stylus pen, wherein a detection frequency for detecting the change in capacitance is changed at a predetermined period.

The detection frequency for detecting the change in capacitance may be alternately changed to a frequency of the driving signal and a frequency of a signal output from the transmitting unit of the stylus pen.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating an appearance of an electronic apparatus including a touchscreen device according to an embodiment of the present invention;

FIG. 2 is a diagram illustrating a panel unit applicable to the touchscreen device according to the embodiment of the present invention;

FIG. 3 is a diagram illustrating a section of the panel unit illustrated in FIG. 2;

FIG. 4 is a diagram illustrating a touchscreen device according to an embodiment of the present invention;

FIGS. 5 and 6 are block diagrams illustrating a stylus pen according to an embodiment of the present invention;

FIG. 7 is a diagram illustrating the stylus pen FIG. 6 in more detail;

FIGS. 8A to 8E are diagrams illustrating signals output from individual components of FIG. 7; and

FIG. 9 is a diagram illustrating a detection frequency of the touchscreen device according to the embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the same or like reference numerals will be used throughout to designate the same or like elements.

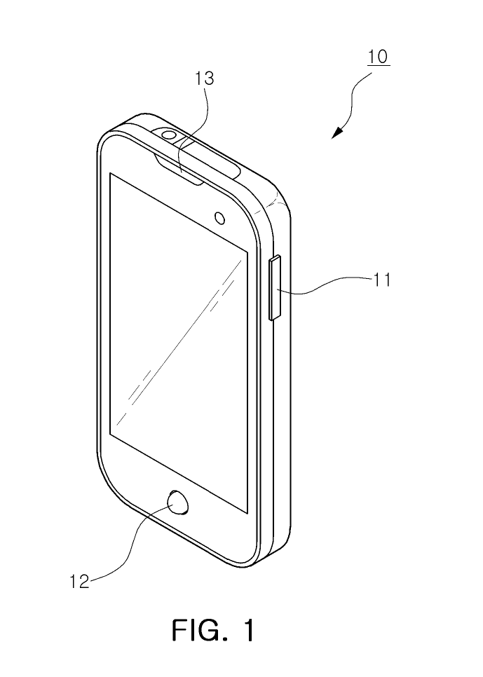

FIG. 1 is a perspective view illustrating an appearance of an electronic apparatus including a touchscreen device according to an embodiment of the invention. Referring to FIG. 1, an electronic apparatus 10 according to the embodiment of the invention may include a display device 11 for outputting an image, an input unit 12, an audio unit 13 for outputting audio, and a touchscreen device integrated with the display device 11.

As shown in FIG. 1, in the case of a mobile apparatus, the touchscreen device may be generally provided to be integrated with the display device and is required to have a high enough degree of light transmissivity to allow an image displayed by the display device to be transmitted therethrough. Therefore, the touchscreen device may be implemented by forming sensing electrodes formed of materials which are transparent and have electrical conductivity such as indium tin oxide (ITO), indium zinc oxide (IZO), zinc oxide (ZnO), carbon nanotubes (CNT) and graphene, on a base substrate formed of transparent film materials, such as polyethylene terephthalate (PET), polycarbonate (PC), polyethersulfone (PES) and polyimide (PI). A bezel region of the display device is provided with a wiring pattern connected to the sensing electrodes made of the transparent conductive materials, in which the wiring pattern is visually shielded by the bezel region, and therefore may be formed of a metal such as silver (Ag), copper (Cu), or the like.

Since it is assumed that the touchscreen device according to the embodiment of the invention is operated as a capacitive type touchscreen device, the touchscreen device may include a plurality of electrodes having a predetermined pattern. Further, the touchscreen device may include a capacitance sensing circuit detecting a change in capacitance occurring in the plurality of electrodes, an analog-to-digital conversion circuit converting output signals from the capacitance sensing circuit into digital values, an operation circuit determining a touch using data converted into the digital values, and the like.

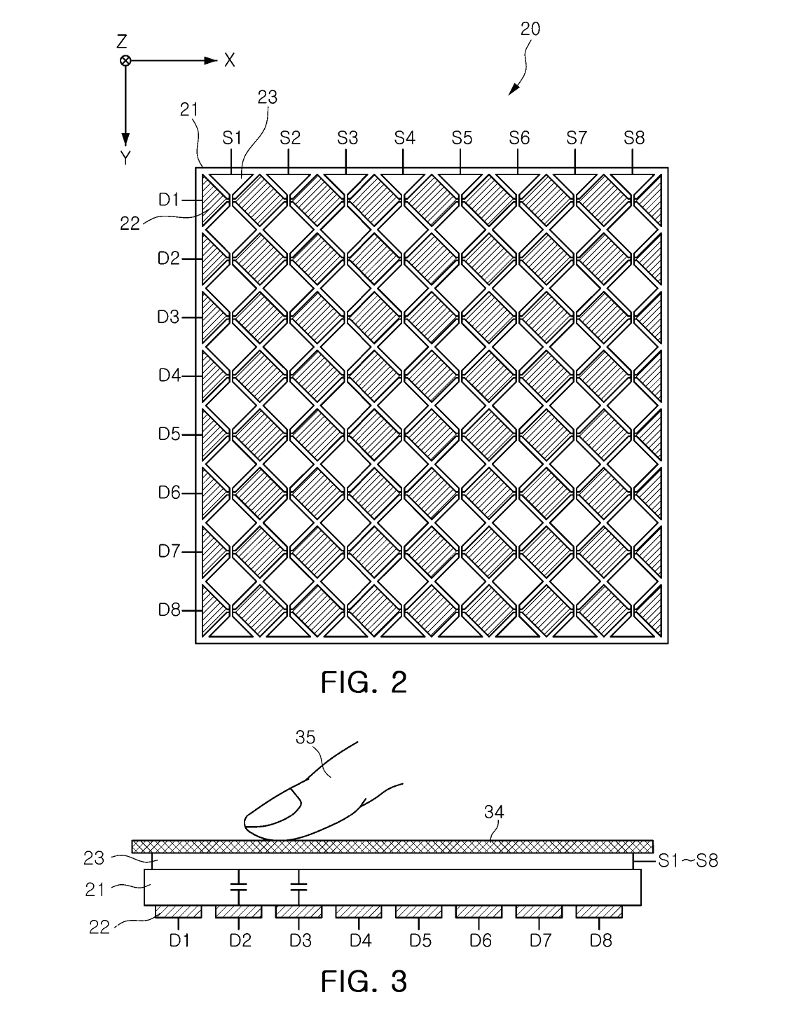

FIG. 2 is a diagram illustrating a panel unit applicable to the touchscreen device according to the embodiment of the invention.

Referring to FIG. 2, a panel unit 20 according to the embodiment of the invention may include a substrate 21 and a plurality of electrodes 22 and 23 disposed on the substrate 21. Although not illustrated in FIG. 2, the plurality of electrodes 22 and 23 may be electrically connected to a wiring pattern of a circuit board attached to one end of the substrate 21 through a wiring and a bonding pad. The circuit board may have a controller integrated circuit mounted thereon to detect a sensing signal generated in the plurality of electrodes 22 and 23 and determine a touch from the sensing signal.

In the case of the touchscreen device, the substrate 21 may be a transparent substrate on which the plurality of electrodes 22 and 23 are formed, and may be formed of plastic materials, such as polyimide (PI), polymethylmethacrylate (PMMA), polyethyleneterephthalate (PET), and polycarbonate (PC), or tempered glass. Further, in addition to the region in which the plurality of electrodes 22 and 23 are formed, in a region in which the wirings connected to the plurality of electrodes 22 and 23 are disposed, a predetermined printed region for visually shielding the wirings generally formed of opaque metals may be formed on the substrate 21.

The plurality of electrodes 22 and 23 may be disposed on one surface or both surfaces of the substrate 21 and in the case of the touchscreen device, may be formed of indium tin-oxide (ITO), indium zinc-oxide (IZO), zinc oxide (ZnO), carbon nanotubes (CNT), graphene based materials, and the like, that are transparent and electrically conductive. FIG. 2 illustrates the plurality of electrodes 22 and 23 having a diamond-shaped pattern, but the plurality of electrodes 22 and 23 may have various polygonal patterns, such as a rectangular or triangular pattern.

The plurality of electrodes 22 and 23 include first electrodes 22 extending in an X-axis direction and second electrodes 23 extending in a Y-axis direction. The first electrodes 22 and the second electrodes 23 are disposed on both surfaces of the substrate 21 or are disposed on different substrates 21 to intersect with each other. In the case in which both of the first electrodes 22 and the second electrodes 23 are disposed on one surface of the substrate 21, a predetermined insulating layer may be partially formed at intersections between the first electrodes 22 and the second electrodes 23.

The touchscreen device electrically connected to the plurality of electrodes 22 and 23 and sensing a touch detects a change in capacitance occurring in the plurality of electrodes 22 and 23 by the touch and senses the touch from the detected change in capacitance. The first electrodes 22 may be connected to channels D1 to D8 in a controller integrated circuit to have a predetermined driving signal applied thereto, and the second electrodes 23 may be connected to channels S1 to S8 to be used for the touchscreen device to detect the sensing signal. In this case, the controller integrated circuit may detect a change in mutual capacitance occurring between the first and second electrodes 22 and 23 as the sensing signal and may be operated by a method of sequentially applying the driving signal to the first electrodes 22 and simultaneously detecting the change in capacitance in the second electrodes 220.

FIG. 3 is a diagram illustrating a section of the panel unit illustrated in FIG. 2. FIG. 3 is a cross-sectional view of the panel unit illustrated in FIG. 2 taken along a Y-Z plane, in which the panel unit may further include a cover lens 34 to which a touch is applied, in addition to the substrate 21 and the plurality of sensing electrodes 22 and 23. The cover lens 34 is disposed on the second electrodes 23 used to detect the sensing signal to have a touch from a touching object 35, such as a finger, applied thereto.

When the driving signal is sequentially applied to the first electrodes 32 through the channels D1 to D8, the mutual capacitance is generated between the first electrodes 32 and the second electrodes 33 to which the driving signal is applied. When the driving signal is sequentially applied to the first electrodes 32, a change in mutual capacitance is generated between the first and second electrodes 32 and 33 adjacent to a region touched by the touching object 35. The change in capacitance may be in proportion to an area of an overlapping region between the touching object 35 and the first and second electrodes 32 and 33 to which the driving signal is applied. In FIG. 3, mutual capacitance generated between the first and second electrodes 32 and 33 connected to the channels D2 and D3 is affected by the touching object 35.

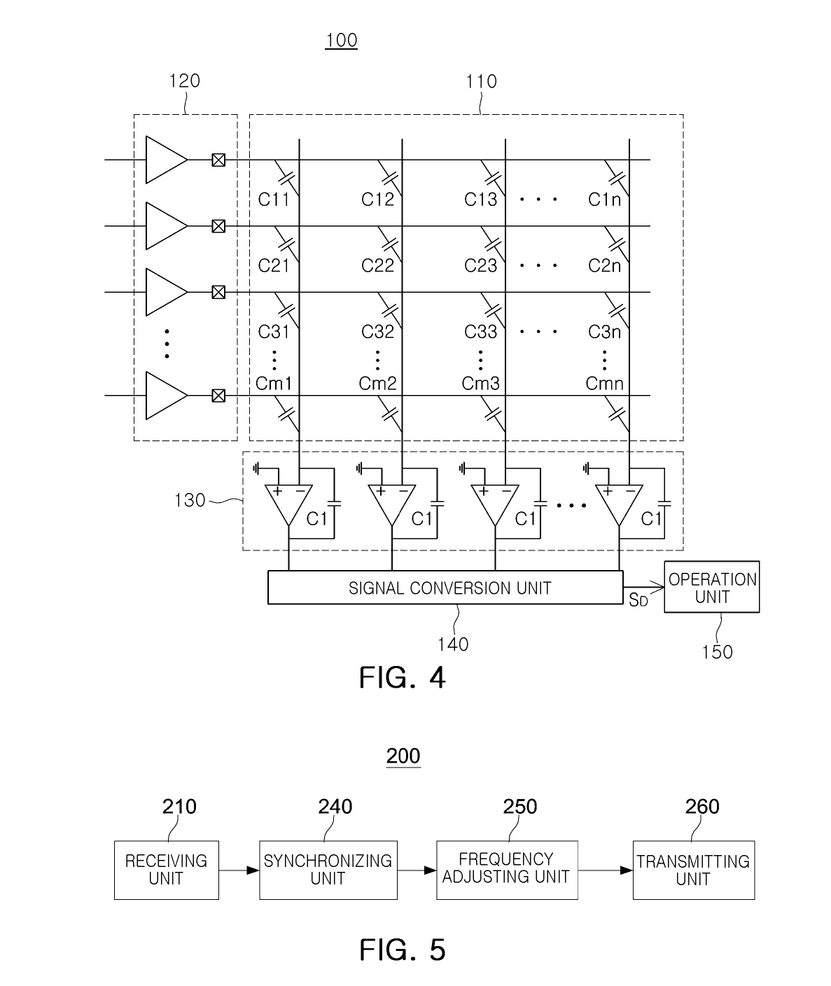

FIG. 4 is a diagram illustrating a touchscreen device according to an embodiment of the invention. Referring to FIG. 4, a touchscreen device 100 according to the embodiment of the invention may include a panel unit 100, a driving circuit unit 120, a sensing circuit unit 130, a signal conversion unit 140, and an operation unit 150.

The panel unit 110 may include a plurality of first electrodes extending in a first axis direction, that is, a horizontal direction of FIG. 4 and a plurality of second electrodes extending in a second axis direction, that is, a vertical direction of FIG. 4, intersecting with the first axis direction. In this case, changes in capacitance C11 to Cmn occur in intersections between the first and second electrodes. The changes in capacitance C11 to Cmn occurring in the intersections between the first and second electrodes may be the changes in mutual capacitance occurring by the driving signal applied to the first electrodes by the driving circuit unit 120. Meanwhile, the driving circuit unit 120, the sensing circuit unit 130, the signal conversion unit 140, and the operation unit 150 may be implemented as a single integrated circuit (IC).

The driving circuit unit 120 may apply a predetermined driving signal to the first electrodes of the panel unit 110. The driving signal may be a square wave signal, a sine wave signal, a triangle wave signal, or the like, having a predetermined frequency, period and amplitude, and may be sequentially applied to the plurality of individual first electrodes. FIG. 4 illustrates that circuits for generating and applying the driving signal are individually connected to the plurality of first electrodes; however, a single driving signal generating circuit may be included and the driving signal may be applied to the plurality of individual first electrodes, using a switching circuit.

The sensing circuit unit 130 may include integrating circuits for detecting the change in capacitance C11 to Cmn from the second electrodes. The integrating circuit may include at least one operational amplifier and a capacitor C1 having a predetermined degree of capacitance. An inversion input terminal of the operational amplifier is connected to the second electrode to convert the change in capacitance C11 to Cmn into an analog signal, such as a voltage signal, and output the analog signal. When the driving signal is sequentially applied to the plurality of individual first electrodes, since the change in capacitance may be simultaneously detected from the plurality of second electrodes, the number of integrating circuits may be provided corresponding to the number (n) of second electrodes. The detection frequency to allow the sensing circuit unit 130 to detect the change in capacitance C11 to Cmn is set to be same as the frequency of the driving signal output from the driving circuit unit to be able to sense the touch applied from the outside. However, the detection frequency of the sensing circuit unit 130 according to the embodiment of the invention may be alternately changed at a predetermined period, that is, the detection frequency may be alternately changed to the driving frequency and a frequency differing from the driving frequency. This will be described below.

The signal conversion unit 140 generates a digital signal S_{D} from an output voltage generated by the sensing circuit unit 130. For example, the signal conversion unit 140 may include a time to digital converter (TDC) circuit measuring a time required for the voltage output by the sensing circuit unit 130 arrives to reach a predetermined reference voltage level and converting the measured time into the digital signal S_{D} or an analog to digital converter (ADC) circuit measuring a change in a voltage level output by the sensing circuit unit 130 for a predetermined time and converting the amount of change into the digital signal S_{D}.

The operation unit 150 determines the touch applied to the panel unit 110 using the digital signal S_{D}. As an example, the operation unit 150 may determine the number, coordinates, gestures, and the like, of touches applied to the panel unit 110.

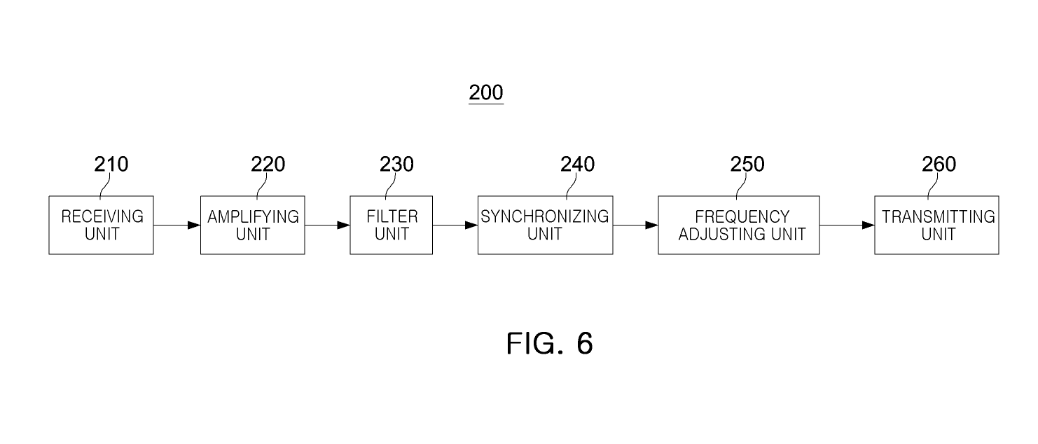

FIGS. 5 and 6 are block diagrams illustrating a stylus pen according to an embodiment of the invention. Referring to FIG. 5, a stylus pen 200 according to the embodiment of the invention may further include a receiving unit 210, a synchronizing unit 240, a frequency adjusting unit 250, and a transmitting unit 260, and referring to FIG. 6, the stylus pen may further include an amplifying unit 220 and a filter unit 230. FIG. 6 illustrates that the filter unit 230 is positioned behind the amplifying unit 220, but the embodiment of the invention is not limited thereto. Therefore, the filter unit 230 may be positioned in front of the amplifying unit 220 or may be positioned behind and in front of the amplifying unit 220.

The receiving unit 210 may be configured of an antenna for receiving a high frequency signal. In particular, the receiving unit 210 may receive a predetermined driving signal generated in the touchscreen device 100 of FIG. 4. When the stylus pen 200 according to the embodiment of the present invention is positioned to be close to the touchscreen device, the receiving unit 210 may receive the driving signal generated in the touchscreen device.

The amplifying unit 220 may amplify the driving signal of the touchscreen device which is received by the receiving unit 210. When the driving signal generated in the touchscreen device is radiated outside the touchscreen device, signal intensity decreases in proportion to a radiated distance to be weakened and the amplifying unit 220 serves to amplify the driving signal having the decreased intensity.

The filter unit 230 may remove noise components from the signal amplified by the amplifying unit 220. The receiving unit 210 may receive an LCD signal generated by the display device integrated with the touchscreen device, a power signal for driving the touchscreen device, and the like, in addition to the driving signal, and the filter unit 230 may previously set a frequency band range to only use the driving signal to remove the noise components, such as the LCD signal and the power signal.

The synchronizing unit 240 may receive the signal from which the noise components are removed from the filter unit 230 to generate a signal synchronized with the received signal. That is, the synchronizing unit 240 may use the signal transferred from the filter unit 230 to generate and output a signal having the same form as the driving signal generated by the touchscreen device.

The frequency adjusting unit 250 may change a frequency of the signal generated by the synchronizing unit 240. In detail, the frequency adjusting unit 250 may multiply or divide the frequency of the synchronized signal generated by the synchronizing unit 240. The signal generated by the frequency adjusting unit 250 is transferred to the transmitting unit 260 and is output from the transmitting unit 260 to the touchscreen device. In this case, the touchscreen device uses the frequency of the driving signal and the frequency of the multiplied or divided signal generated in the frequency adjusting unit as the detection frequency when detecting the change in capacitance.

That is, as described above, the touchscreen device detects the change in capacitance by changing the detection frequency at a predetermined period. In this case, the touchscreen device alternately changes the detecting frequency by using the frequency of the driving signal and the frequency of the signal generated in the frequency adjusting unit 250 to be able to simultaneously detect a touch from a finger, and the like, and a touch from the stylus pen.

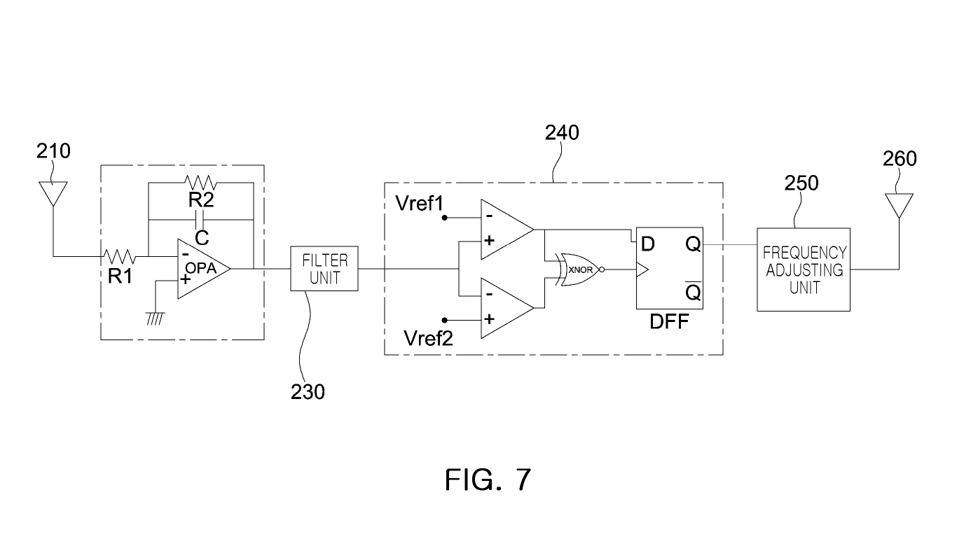

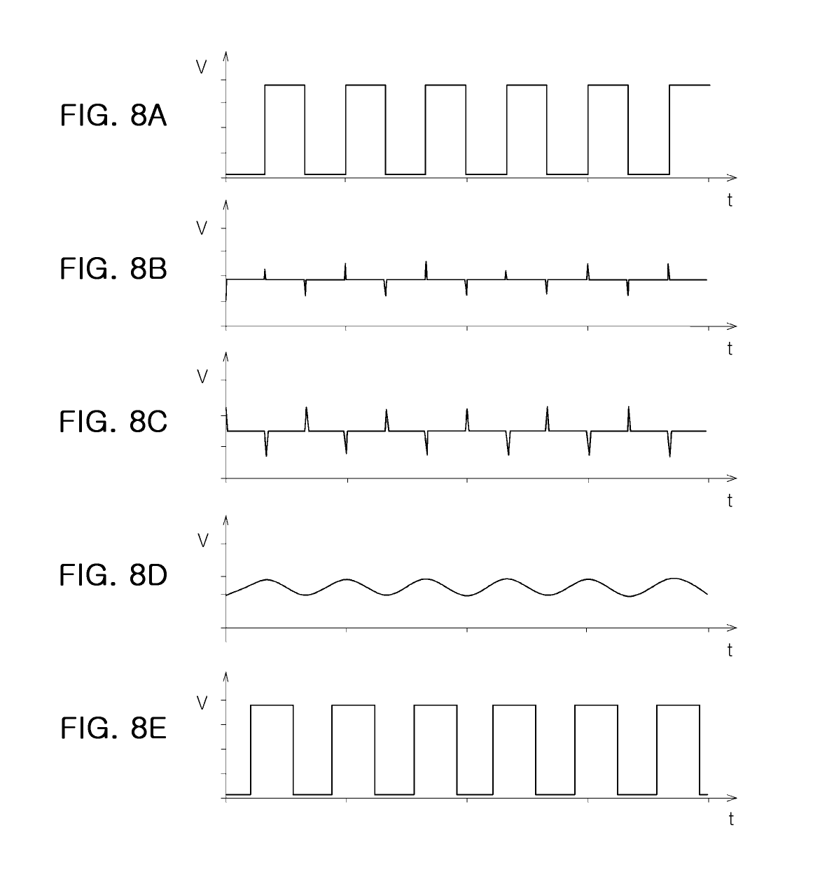

FIG. 7 is a diagram illustrating the stylus pen of FIG. 6 in more detail, and FIGS. 8A to 8E are diagrams illustrating signals output from individual components of FIG. 7. Hereinafter, the stylus pen according to the embodiment of the invention will be described in more detail with reference to FIGS. 7 and 8. However, descriptions the same as or overlapping with those of FIGS. 6 and 7 will be omitted.

FIG. 8A is a diagram illustrating a driving signal generated by the touchscreen device according to the embodiment of the invention. When the driving signal generated by the touchscreen device is radiated outside the touchscreen device, signal intensity decreases in proportion to the radiated distance to be weakened, such that the receiving unit 210 receives a signal as illustrated in FIG. 8B.

The signal received by the receiving unit 210 is amplified by the amplifying unit 220. As illustrated in FIG. 7, the amplifying unit 220 according to the embodiment of the invention may include an operational amplifier (OPA) including a non-inversion terminal connected to aground, a first resistor R1 connected to an inversion terminal of the operational amplifier (OPA) to have the signal received by the receiving unit 210 applied thereto, a second resistor R2 connecting the inversion terminal of the operational amplifier (OPA) to an output terminal thereof, and a capacitor C connected to the second resistor in parallel. The amplifying unit 220 inversely amplifies the signal received by the receiving unit 210 depending on a resistance ratio of the first resistor R1 and the second resistor R2 and an amplification factor of the operational amplifier, and the capacitor C removes the noise components introduced into the received signal. In the embodiment of the invention, the received signal is inversely amplified, which is only an example. Therefore, it is apparent that the amplifying unit 220 may perform inversion amplification and non-inversion amplification. The signal output from the amplifying unit 220 is illustrated in FIG. 8C.

The filter unit 230 is configured of a band pass filter (BPF) through which only a signal within a preset frequency band passes to be able to remove the above-mentioned LCD signal and power signal. In this case, the signal output from the filter unit 230 is illustrated in FIG. 8D.

The synchronizing unit 240 may include a first comparator COMP1 including an non-inversion terminal having the signal transferred from the filter unit 230 applied thereto and having a preset first reference voltage Vref1 applied thereto, a second comparator COMP2 including a non-inversion terminal having the signal transferred from the filter unit 230 applied thereto and having a preset second reference voltage Vref2 applied thereto, an exclusive-NOR (XNOR) gate XNOR-operating output signals from the first and second comparators COMP1 and COMP2, and a D-flip flop (DFF) including an input terminal having the output signal of the first comparator COMP1 applied thereto and a clock signal terminal having an output signal of the XNOR gate applied thereto.

In this case, the preset first and second reference voltages Vref1 and Vref2 may be set to have the same magnitude but different polarities. According to the embodiment of the invention, the first reference voltage Vref1 may be set as a voltage having a positive polarity and the second reference voltage Vref2 may be set as a voltage having a negative polarity, and the magnitude thereof may be set to be lower than a maximum voltage level and a minimum voltage level of the signal transferred from the filter unit 230.

The XNOR gate according to the embodiment of the invention is only an example and therefore, the invention is not limited thereto. Therefore, the XNOR gate may be replaced with other logic circuits able to perform XNOR operations. For example, the XNOR gate according to the embodiment of the invention may be replaced with an exclusive-OR (XOR) gate and an inverter.

The signal output from the synchronizing unit 240 is the same as the signal illustrated in FIG. 8E, which has the same form as the signal illustrated in FIG. 8A.

The frequency adjusting unit 250 changes a frequency by multiplying or dividing the signal generated by and transferred from the synchronizing unit 240.

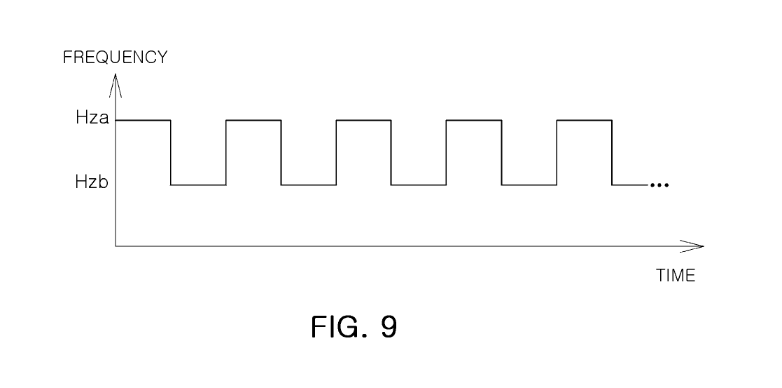

In this case, the touchscreen device according to the embodiment of the invention uses the frequency of the driving signal output from the driving circuit and the frequency of the multiplied or divided signal generated in the frequency adjusting unit 250 as the detection frequency when detecting the change in capacitance. That is, the touchscreen device detects the change in capacitance by changing the detection frequency at a predetermined period. In this case, as illustrated in FIG. 9, the touchscreen device alternately changes the detection frequency by using a frequency Hza of the driving signal and a frequency Hzb of the signal generated in the frequency adjusting unit 250 to be able to simultaneously detect a touch from a finger, and the like, and a touch from a stylus pen.

The transmitting unit 260 may be configured of an antenna, and the like, to transmit the signal transferred from the frequency adjusting unit 250 to the external touchscreen device.

As set forth above, according to embodiments of the invention, a touch from a stylus pen and a touch from a finger, and the like, can be simultaneously recognized.

While the present invention has been shown and described in connection with the embodiments, it will be apparent to those skilled in the art that modifications and variations can be made without departing from the spirit and scope of the invention as defined by the appended claims.

What is claimed is:

1. A stylus pen, comprising:
a receiving unit receiving a predetermined driving signal;
a synchronizing unit generating a signal synchronized with the received driving signal;
a frequency adjusting unit changing a frequency of the synchronized signal; and
a transmitting unit transmitting a signal output from the frequency adjusting unit.

2. The stylus pen of claim 1, further comprising a filter unit passing a signal within a preset frequency band, among the received driving signals.

3. The stylus pen of claim 2, wherein the filter unit includes a band pass filter.

4. The stylus pen of claim 1, further comprising an amplifying unit amplifying the received driving signal.

5. The stylus pen of claim 4, wherein the amplifying unit inversely amplifies the received driving signal.

6. The stylus pen of claim 1, wherein the synchronizing unit includes:
a first comparator comparing a voltage of the received driving signal with a preset first reference voltage;
a second comparator comparing the voltage of the received driving signal with a preset second reference voltage;
an XNOR gate XNOR-operating output signals from the first and second comparators; and
a D-flip flop including an input terminal having the output signal of the first comparator applied thereto and a clock signal terminal having an output signal of the XNOR gate applied thereto.

7. The stylus pen of claim 6, wherein the first comparator includes an inversion terminal having the first reference voltage applied thereto and a non-inversion terminal having the received driving signal applied thereto, and
the second comparator includes an inversion terminal having the second reference voltage applied thereto and a non-inversion terminal having the received driving signal applied thereto.

8. The stylus pen of claim 6, wherein the first reference voltage has a predetermined level of positive voltage, and
the second reference voltage has a predetermined level of negative voltage.

9. The stylus pen of claim 1, wherein the frequency adjusting unit multiplies or divides a frequency of a signal output from the synchronizing unit.

10. The stylus pen of claim 1, wherein the driving signal is generated in a controller integrated circuit of a capacitive touchscreen device and is applied to an electrode of a panel unit of the touchscreen device.

11. A touchscreen module, comprising:
the stylus pen of claim 1; and
a touchscreen device including a panel unit and a controller integrated circuit detecting a change in capacitance by applying a predetermined driving signal to the panel unit to sense a touch from the stylus pen,
wherein a detection frequency for detecting the change in capacitance is changed at a predetermined period.

12. The stylus pen of claim 11, wherein the detection frequency for detecting the change in capacitance is alternately changed to a frequency of the driving signal and a frequency of a signal output from the transmitting unit of the stylus pen.
